(19) United States
(12) Patent Application Publication
(10) Pub. No.: US 2022/0058939 A1
(43) Pub. Date: Feb. 24, 2022

(54) Smoke Detector Availability Test

(71) Applicant: Tyco Fire & Security GmbH, Nuehausen am Rheinfall (CH)

(72) Inventor: Stephen John Penney, Feltham (GB)

(21) Appl. No.: 16/606,306

(22) PCT Filed: Apr. 20, 2018
(86) PCT No.: PCT/EP2018/060175

§ 371 Date: Oct. 18, 2019

Related U.S. Application Data
(60) Provisional application No. 62/487,524, filed on Apr. 20, 2017.

(51) Int. Cl. G08B 29/14; G08B 17/107

(52) U.S. Cl. CPC G08B 29/145; G08B 17/107

(57) ABSTRACT

The present invention relates to a system for testing the availability of a detector for detecting smoke. More specifically, the present invention relates to a detector with a testing unit arranged to detect whether the detector has been covered, such that it is unable to perform its function as a smoke detector.

Smoke detectors are subject to regular tests and modern smoke detectors monitor internally that they remain operable. However, detectors are often in position for considerable periods and building redecorations, refurbishments, or other works that could generate false alarms may take place while they are installed. When this happens, the building manager may well take precautions to protect the site from false alarms and the detector from being compromised by paint, dust etc. Often this protection consists of taping or attaching a plastic bag over the detector to prevent the ingress of contaminants. This may serve the purpose well, but it also prevents the ingress of smoke if there were a fire.

The practice of covering the detector to protect it may be acceptable for very short periods, but if building works continue for a long period after the initial ‘dirty’ work is completed it is unlikely that the detector would be uncovered, thus compromising the safety of the site.

Presently, in order to check whether detectors are covered, a visual assessment is required. In this manner, an engineer performing the assessment must walk around a protected site and perform a visual assessment for each individual detector which is part of a system. This method of checking the availability of detectors has been long used in the industry of fire detection and is generally accepted as the best known method.

In an embodiment of the invention, there is provided a smoke detector test system, comprising: a fire alarm control panel; a smoke detector in communication with the fire alarm control panel; a test unit integral or immediately adjacent to the smoke detector for detecting an obstruction that has been placed over the smoke detector, the test unit providing a signal to the fire alarm control panel indicating if the detector is unavailable to detect smoke. This test unit detects the protection that has been placed over the detector, e.g., a bag, tape, dust over, etc., and signals back to a fire alarm control panel that the detector is unavailable to detect fire.

The test unit may comprise an assembly that plugs directly into the detector's existing base. This provides a proximity sensor means to identify an obstruction in the immediate vicinity of the detector. This may also be combined with an in situ detector test means for producing a test aerosol. The combination of the longer clearing time of the aerosol from the detector and the activation of the proximity sensor would give a good indication that the detector is covered in a way that would prevent smoke access.

The description below covers a proposed approach; but the main focus is the application of this technique for smoke detector availability detection and not the principle of generation of proximity sensing, or mechanics of doing this, although suggested embodiments are provided:
The use of proximity sensor as a detector availability test apparatus
The use of proximity sensor to initiate a secondary in situ detector tester to validate smoke entry (or exit)
The combination of test aerosol persistence in the detector chamber from an in situ detector tester and proximity sensor output to determine that detector air entry has been compromised.

In at least one embodiment, the test unit may be an integral part of the in situ aerosol detector and may comprise a proximity sensor that may be a combination of one or more of, but not limited to, several technologies, including capacitive, ultrasonic and/or optical.

The smoke detector may also be powered from a detection loop, the test unit further comprising a proximity sensor, the proximity sensor operating a test cycle utilizing power from the detection loop.

The test unit may be an in situ detector test module which is sandwiched between the detector and the detector's mounting base.

### BRIEF DESCRIPTION OF THE DRAWINGS

Other advantages and benefits of embodiments of the present invention will become apparent from a consideration of the following description and accompanying drawings, in which:

FIG. 1 shows a structural view of the present invention.

### DETAILED DESCRIPTION

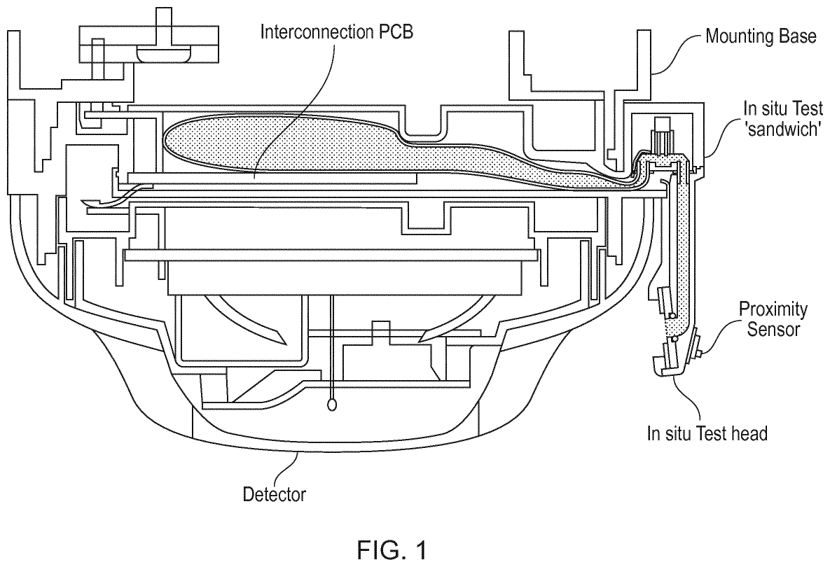

In a first embodiment in accordance with FIG. 1, there is provided a detector mounted on a mounting base. The detector is provided with a chamber arranged to allow ingress of particulates, such that smoke may be detected. The detector is also be provided with a test unit, arranged to test whether the detector is compromised. The test unit comprises a proximity sensor. The proximity sensor is located on an outer surface of the detector. The proximity sensor is driven by a controller. The controller can be a part of the test unit or a part of the detector. The proximity sensor is arranged to detect the presence of objects in the immediate vicinity of the detector. In this manner, should an object, such as a bag, be placed over the detector, the proximity sensor detects the object and the controller sends a signal to the fire alarm control panel indicating that an object has been detected. Alternatively, the controller sends a signal to the detector which, in turn, sends a signal to the fire alarm control panel indicating that an object has been detected.

In order that the proximity sensor does not produce a false notification of the detector being covered, the controller sends a signal to the fire alarm control panel only after a certain amount of time (a threshold time) has elapsed. For example, the threshold time may be five seconds, in order that objects passing by the detector do not trigger a false notification. Alternatively, the threshold time may be 1 hour, in order that the detector can be temporarily protected during redecoration of a room etc. without triggering a false notification. In this manner, the threshold time may be one of a variety of possible times depending on the situational requirements. The threshold time may be determined and/or altered, by a user, from the fire alarm control panel or, alternatively, may be predefined by a manufacturer of the detector.

In the first embodiment, the detector further comprises an in situ aerosol tester, as part of the test unit. The aerosol tester may be of a type as described in PCT publication no. WO/2017/060716. In this embodiment, the proximity sensor and the in situ detector are driven from the tester electronics (the controller), but would normally operate more frequently than the aerosol tester. The aerosol tester can be used to confirm the presence of a cover, as a result of a signal from the proximity sensor. If the presence of a cover over the detector is indicated by the proximity sensor, the controller may temporarily isolate the detector from communication with the fire control panel. Once the detector is isolated, the aerosol tester can be used to perform an in situ aerosol test, and finally indicate the result back via the normal (or other) communication route. If the aerosol test indicates that a testing fluid used in the test persists for longer than a threshold time, then it can be determined that the egress of particulates from the chamber has been compromised. From this, it can be inferred that the ingress of particulates into the chamber of the detector has also been compromised. Specifically, in combination with the signal from the proximity sensor, it can be determined that a cover has been placed over the detector.

In a second embodiment, the test unit comprises only a proximity sensor, without an in situ aerosol tester. In a similar manner to above, the proximity sensor is arranged to detect the presence of objects in the immediate vicinity of the detector. Should an object, such as a bag, be placed over the detector, the proximity sensor detects the object and the controller sends a signal to the fire alarm control panel indicating that an object has been detected. Alternatively, the controller sends a signal to the detector which, in turn, sends a signal to the fire alarm control panel indicating that an object has been detected.

In a third embodiment, the test unit comprises only an in situ aerosol tester, without a proximity sensor. In a similar manner to above, when performing an aerosol test, the persistence of a testing fluid within the chamber of the detector can be used to indicate that the detector has been covered. In this manner, if the detector, when being tested, indicates that smoke is present in the chamber for a period of time which exceeds a threshold time, then it can be determined that egress of smoke from the chamber, or generally away from the detector, is inhibited. As such, it can be inferred that ingress of smoke into the chamber is also inhibited.

In embodiments comprising a proximity sensor, the proximity sensor is located in any position on the outer surface of the detector. For example, as shown in FIG. 1, the sensor is located on the head of the aerosol tester. In this manner, the sensor is capable of determining that the detector is covered, even if the aerosol tester is capable of performing a test. In an alternative embodiment, the proximity senor may be placed elsewhere on the outer surface of the detector. For example, the sensor may be located close to an entry point of the chamber, so as to only produce a signal if the entry point of the chamber is covered. This reduces the chance of a false notification if an external area of the detector is covered in such a manner that particulates are still capable of entering the chamber of the detector.

The way that the detector is isolated and the exact control of the test would depend on the communication protocol utilized by the fire detection system used. Within a suggested embodiment there is an existing in situ detector test module which is in the form of a ‘sandwich’ component between the detector and the mounting base. All electrical connections may go through this component, as such it would be able to temporarily suspend communication between the detector and the fire control panel and communicate with the panel directly to enable the generation of a fault/trouble signal, or indicate that a test is in progress and the panel should not generate an alarm from that detection point.

On a regular schedule (for example, daily), either determined by an on board clock, or by signaling from the panel, the proximity sensor may operate its test cycle utilizing power from the detection loop. Although there would be a noticeable current draw from the test, if this were under panel control it can be ensured that only a limited number of tests would be performed simultaneously on any given loop.

Features of the present invention are defined in the appended claims. While particular combinations of features have been presented in the claims, it will be appreciated that other combinations, such as those provided above, may be used.

1. A smoke detector test system, comprising:
a fire alarm control panel;
a smoke detector in communication with the fire alarm control panel; and
a test unit integral or immediately adjacent to the smoke detector, wherein the test unit comprises an in situ aerosol tester, for detecting an obstruction that has been placed over the smoke detector by testing egress of particles from the detector, the test unit providing a signal to the fire alarm control panel indicating if the detector is unavailable to detect smoke.

2. The system of claim 1, wherein the test unit comprises an assembly that plugs directly into the smoke detector's existing base.

3. (canceled)

4. The system of claim 1, wherein, in response to detecting an obstruction, the test unit is arranged to isolate the smoke detector from the fire alarm control panel and perform an in situ aerosol test.

5. (canceled)

6. (canceled)

7. (canceled)

8. The system of claim 1, wherein the test unit provides the signal to the fire alarm control panel if the detector is unavailable for a time period which exceeds a threshold time.

9. The system of claim 1, wherein the test unit is arranged to isolate the detector from the fire control panel in response to a determination that the detector is unavailable to detect smoke.

10. A smoke detector test system, comprising:
a fire alarm control panel;
a smoke detector in communication with the fire alarm control panel; and
a test unit integral or immediately adjacent to the smoke detector for detecting an obstruction that has been placed over the smoke detector, the test unit providing a signal to the fire alarm control panel indicating if the detector is unavailable to detect smoke, wherein the test unit comprises a proximity sensor, external to a test chamber of the smoke detector.

11. The system of claim 10, wherein test unit comprises an assembly that plugs directly into the smoke detector's existing base.

12. The system of claim 10, wherein, in response to detecting an obstruction, the test unit is arranged to isolate the smoke detector from the fire alarm control panel and perform an in situ aerosol test.

13. The system of claim 10, wherein the smoke detector is powered from a detection loop, the proximity sensor operating a test cycle utilizing power from the detection loop.

14. The system of claim 10, wherein the proximity sensor is a combination of at least one or more of the following technologies: capacitive, ultrasonic and/or optical.

15. The system of claim 10, the test unit is an in situ detector test module which is sandwiched between the detector and the detector's mounting base.

16. The system of claim 10, wherein the test unit provides the signal to the fire alarm control panel if the detector is unavailable for a time period which exceeds a threshold time.

17. The system of claim 10, wherein the test unit is arranged to isolate the detector from the fire control panel in response to a determination that the detector is unavailable to detect smoke.
